(19) United States
(12) Patent Application Publication
(10) Pub. No.: US 2015/0024261 A1
(43) Pub. Date: Jan. 22, 2015

(54) Battery Cell for Secondary Batteries

(71) Applicant: SK Innovation Co., Ltd., Seoul (KR)

(72) Inventor: Ming Zhe Kong, Daejeon (KR)

(21) Appl. No.: 14/382,821

(22) PCT Filed: Feb. 15, 2013
(86) PCT No.: PCT/KR2013/001190

§ 371 Date: Sep. 4, 2014

(30) Foreign Application Priority Data
Mar. 7, 2012 (KR) 10-2012-0023538

(51) Int. Cl. H01M 2/26; H01M 2/06

(52) U.S. Cl. CPC H01M 2/26; H01M 2/06
USPC 429/179; 429/178

(57) ABSTRACT

Provided is a battery cell for a secondary battery, and more particularly, a battery cell for a secondary battery basically including an electrode plate, a case, and electrode tabs. According to the battery cell for the secondary battery in the present invention, since a plurality of battery cells are electrically connected to each other only with a structure of the electrode tabs, a separate component for connection of the electrode tabs is not required, such that it is easy to secure a space at the time of manufacturing a battery pack. In addition, the manufacturing process may be simplified by easy assembly of the battery cells. Further, stability and reliability of the battery cells may be secured.

### TECHNICAL FIELD

The present invention relates to a battery cell for a secondary battery, and more particularly, to a battery cell for a secondary battery basically including an electrode plate, a case, and electrode tabs.

### BACKGROUND ART

In general, a secondary battery is capable of being recharged and having a large capacity. As a representative secondary battery, there are a nickel cadmium battery, a nickel hydrogen battery, and a lithium ion battery, and so on. Among the secondary batteries, the lithium ion battery has received attention as a next generation power source due to excellent properties such as a long lifespan, high capacity, and the like. Among them, the lithium secondary battery has an operation voltage of 3.6 V or more to be used as a power supply of a portable electronic device or to be used in a high power hybrid automobile by connecting batteries in series. As compared to the nickel-cadmium battery or the nickel-metal hydride battery, the operation voltage of the lithium secondary battery is three times higher than those of the nickel-cadmium battery or the nickel-metal hydride battery, and energy density property per unit weight is also excellent, such that the use of the lithium secondary battery has rapidly increased.

The lithium secondary battery is capable of being manufactured so as to have various shapes, and cylinder typed and prismatic typed lithium secondary batteries have been usually used as a representative shape. A lithium polymer battery which is recently spotlighted is manufactured in a pouched type having flexibility, such that the shape thereof is relatively varied. In addition, the lithium polymer battery has excellent stability and light weight, such that it is advantageous for slimness and lightness of the portable electronic device.

A battery cell for the secondary battery is configured to include a battery part and a case providing a space where the battery part is accommodated. It is general that a plurality of battery cells are stacked to be used, wherein for connection between the stacked battery cells, electrode tabs electrically connecting the battery part are exposed to the outside of the case, and each electrode tab is connected in series or in parallel to supply a large capacity voltage or current.

Various technologies for connecting each electrode tab in the battery cell having the above-described configuration have already been known; however, they have disadvantages in that a largely occupied space and a welding process are required. Therefore, a technology of a battery cell occupying a small space and having an easy assembly process in connecting each battery cell is demanded to be developed.

### DISCLOSURE

### Technical Problem

An object of the present invention is to provide a battery cell for a secondary battery having a structure of electrode tabs electrically connecting a plurality of battery cells only by stacking cases.

### Technical Solution

In one general aspect, a battery cell for a secondary battery includes: a battery part including electrode plates disposed at an predetermined interval and a separator provided between each electrode plate; a case enclosing the battery part; and a cathode tab and an anode tab each having one side electrically connected to the electrode plate and the other side exposed to an outer side of the battery part, wherein the outer side of each of the cathode tab and the anode tab is closely adhered to a stacked surface of the case.

The other side of the cathode tab may be closely adhered to one surface of the case, and the other side of the anode tab may be closely adhered to the other surface of the case.

The cathode tab and the anode tab may be exposed to the outer side through a bonding surface of the case, the exposed cathode tab may be bent toward one surface of the case, the exposed anode tab may be bent toward the other surface of the case, and an insulation layer may be formed between the cathode tab and the anode tab on the bonding surface of the case.

The cathode tab may penetrate through one surface of the case and has the other side part bent so as to contact one surface of the case, and the anode tab may penetrate through the other surface of the case and has the other side part bent so as to contact the other surface of the case.

The cathode tab may be exposed to an outer side through any one side of the bonding surfaces of the case, and bent toward one surface of the case, and the anode tab may be exposed to an outer side through the other side of the bonding surfaces of the case, and bent toward the other surface of the case.

### Advantageous Effects

With the battery cell for the secondary battery having the configuration as described above, since a plurality of battery cells are electrically connected to each other only with a structure of electrode tabs, a separate component for connection of the electrode tabs is not required, such that it is easy to secure a space at the time of manufacturing a battery pack. In addition, the manufacturing process may be simplified by easy assembly of the battery cells. Further, stability and reliability of the battery cells may be secured.

### DESCRIPTION OF DRAWINGS

The above and other objects, features and advantages of the present invention will become apparent from the following description of preferred embodiments given in conjunction with the accompanying drawings, in which:

FIG. 1 is a perspective view of a battery cell according to a first exemplary embodiment of the present invention.

FIG. 2 is a longitudinal cross-sectional view of FIG. 1.

FIG. 3 is a perspective view showing a state in which the battery cells according to the first exemplary embodiment of the present invention are stacked.

FIG. 4 is an exploded perspective view of FIG. 3.

FIG. 5 is a perspective view of a battery cell according to a second exemplary embodiment of the present invention.

FIG. 6 is a longitudinal cross-sectional view of FIG. 5.

FIG. 7 is a perspective view of a battery cell according to a third exemplary embodiment of the present invention.

FIG. 8 is a longitudinal cross-sectional view of FIG. 7.

### DETAILED DESCRIPTION OF MAIN ELEMENTS

10, 20, 30: BATTERY CELL

11, 21, 31: BATTERY PART

12, 22, 32: CASE

12a, 22a, 32a: BONDING SURFACE

13, 23, 33: CATHODE TAB

14, 24, 34: ANODE TAB

### Best Mode

Hereinafter, various exemplary embodiments of a battery cell for a secondary battery according to the present invention are described in detail with reference to the accompanying drawings.

### Example 1

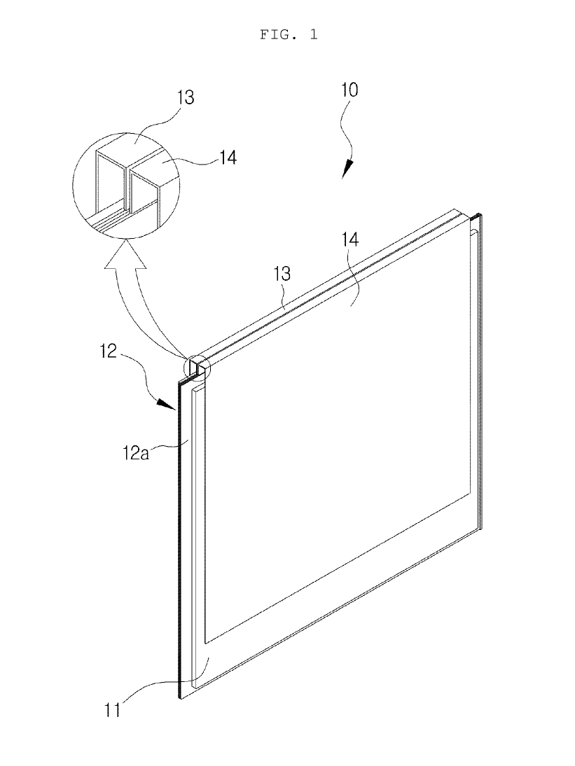

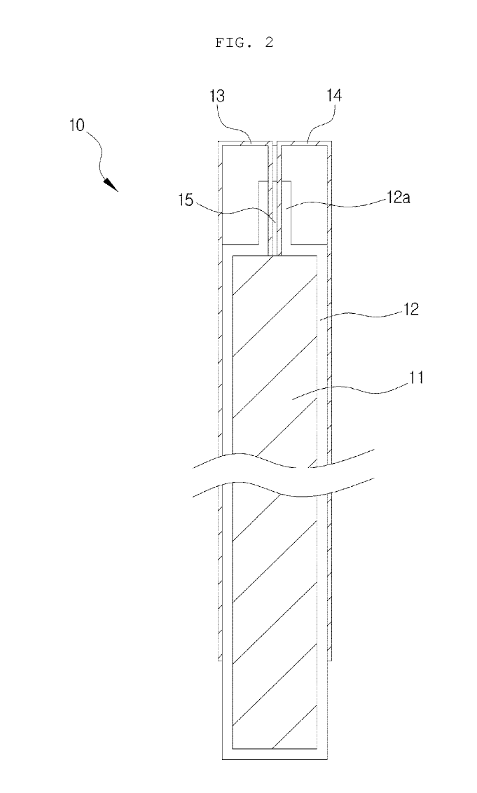

FIGS. 1 and 2 show a battery cell for a secondary battery according to a first exemplary embodiment of the present invention, the battery cell 10 including a battery part 11 and a case 12 providing a space where the battery part 11 is accommodated.

The battery part 11 has a shape in which a cathode plate, a separator, and an anode plate are sequentially disposed and wound in one direction or in which a plurality of sheets of cathode plates, separators, and anode plates are stacked. One side part of each cathode plate of the battery part 11 is electrically connected to a cathode tab 13, and one side part of each anode plate thereof is electrically connected to an anode tab 14.

Other side part of each of the cathode tab 13 and the anode tab 14 is exposed to the outside through a bonding surface 12a of the case 12. Here, it is shown in the drawings that the other side part of each of the cathode tab 13 and the anode tab 14 is exposed to the outside through a bonding surface at an upper side of the case 12; however, the other side part thereof may be exposed through a bonding surface at any one side among upper, lower, left and right sides. Meanwhile, in a case of a single forming schemed battery cell, it is desired that the cathode tab 13 and the anode tab 14 are not exposed to a side end of which the battery cell has a bending part formed therein.

The other side part of the exposed cathode tab 13 is bent toward one surface of the case 12, and is closely adhered and fixed to one surface of the case 12. The cathode tab 13 and the case 12 may be adhered and fixed by general adhesive members. In addition, the other side part of the exposed anode tab 14 is bent toward the other surface of the case 12, and is closely adhered and fixed to the other surface of the case 12. The anode tab 14 and the case 12 may be adhered and fixed by general adhesive members. Here, it is desired that an insulation layer 15 for insulation between the cathode tab 13 and the anode tab 14 is formed on the bonding surface 12a of the case 12 formed with the cathode tab 13 and the anode tab 14. The insulation layer 15 is provided between the cathode tab 13 and the anode tab 14 on the bonding surface 12a of the case 12, and may be made of any insulation material. As an example thereof, the insulation layer 15 may be made of the same material as the case 12.

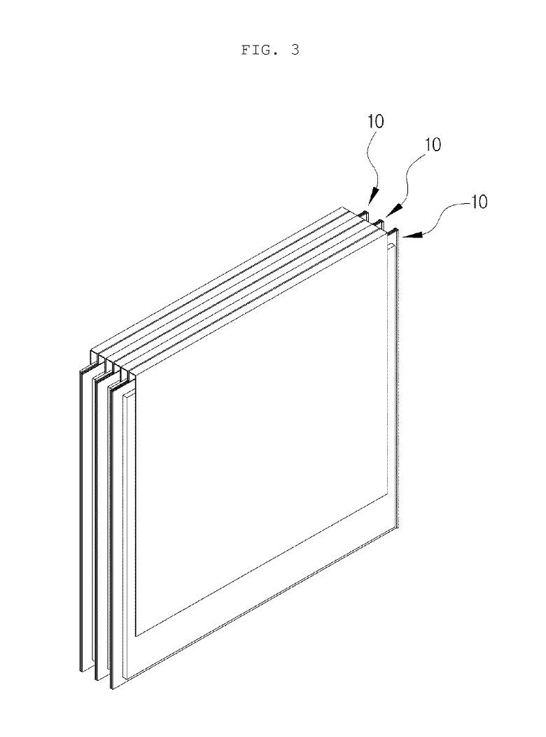

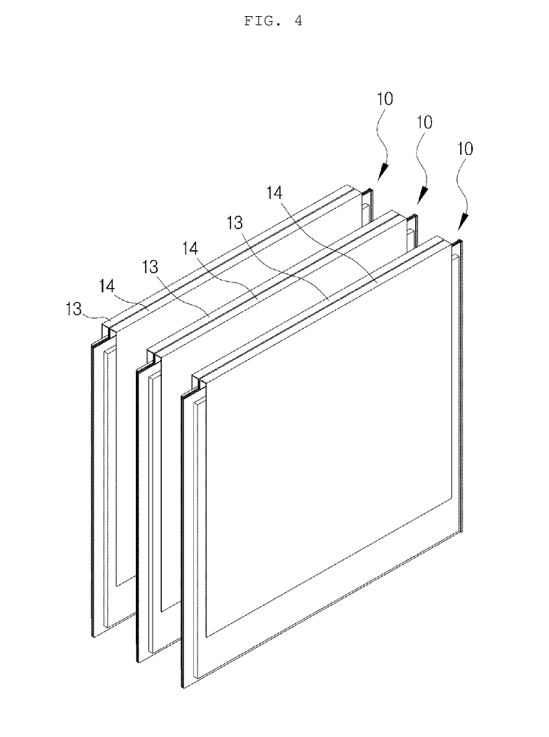

In a case of stacking the plurality of battery cells 10 according to the first exemplary embodiment of the present invention as configured above, when one surface of the battery cell 10 contacts the other surface of the neighboring battery cell 10 as shown in FIGS. 3 and 4, the cathode tab 13 and the anode tab 14 may be closely adhered without a separate component for connection to be electrically connected to each other.

### Example 2

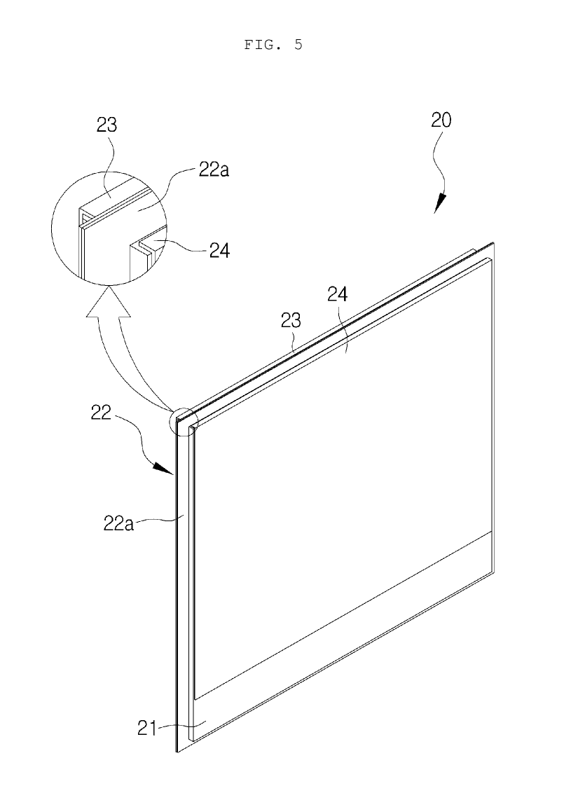

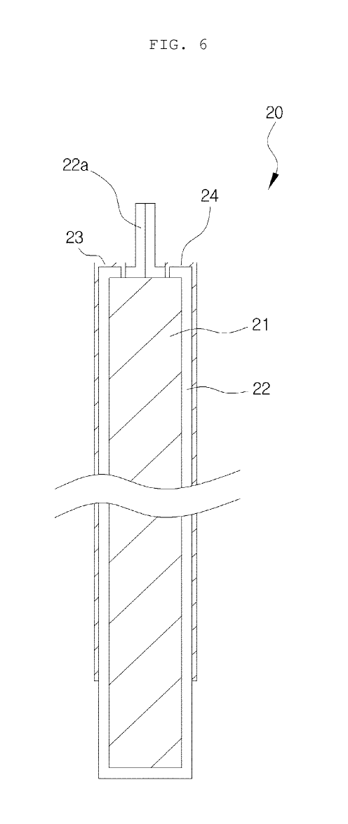

FIGS. 5 and 6 show a battery cell for a secondary battery according to a second exemplary embodiment of the present invention, the battery cell 20 including a battery part 21 and a case 22 providing a space where the battery part 21 is accommodated.

The battery part 21 has a shape in which a cathode plate, a separator, and an anode plate are sequentially disposed and wound in one direction or in which a plurality of sheets of cathode plates, separators, and anode plates are stacked. One side part of each cathode plate of the battery part 21 is electrically connected to a cathode tab 23, and one side part of each anode plate thereof is electrically connected to an anode tab 24.

The other side part of the cathode tab 23 penetrates through one surface of the case 22 to be exposed to the outside. It is shown in the drawings that the other side part of the cathode tab 23 penetrates through an upper side on one surface of the case 22; however, the other side part thereof may penetrate through any one side among upper, lower, left, and right sides. The other side part of the penetrated cathode tab 23 may be bent and fixed in contact with one surface of the case 22. The cathode tab 23 and the case 22 may be adhered and fixed by general adhesive members. General sealing members may be applied between the penetrated part of the case 22 and the cathode tab 23 to thereby seal the case 22.

The other side part of the anode tab 24 penetrates through the other surface of the case 22 to be exposed to the outside. It is shown in the drawings that the other side part of the anode tab 24 penetrates through an upper side on the other surface of the case 22; however, the other side part thereof may penetrate through any one side among upper, lower, left, and right sides. The other side part of the penetrated anode tab 24 may be bent and fixed in contact with the other surface of the case 22. The anode tab 24 and the case 22 may be adhered and fixed by general adhesive members. General sealing members may be applied between the penetrated part of the case 22 and the anode tab 24 to thereby seal the case 22.

In the battery cell 20 according to the second exemplary embodiment of the present invention as configured above, since the cathode tab 23 and the anode tab 24 are exposed through one surface and the other surface of the battery cell 20, respectively, as compared to the first exemplary embodiment, the insulation between the cathode tab 23 and the anode tab 24 is not required.

### Example 3

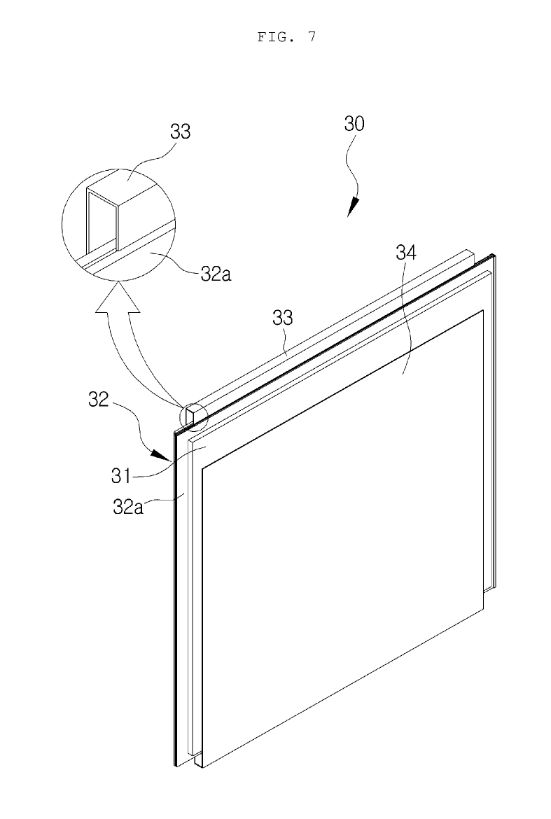

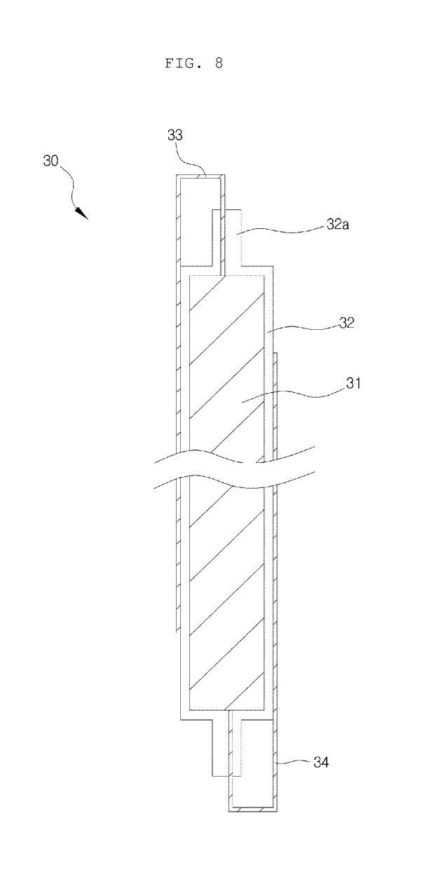

FIGS. 7 and 8 show a battery cell 30 for a secondary battery according to a third exemplary embodiment of the present invention, the battery cell 30 including a battery part 31 and a case 32 providing a space where the battery part 31 is accommodated.

The battery part 31 has a shape in which a cathode plate, a separator, and an anode plate are sequentially disposed and wound in one direction or in which a plurality of sheets of cathode plates, separators, and anode plates are stacked. One side part of each cathode plate of the battery part 31 is electrically connected to a cathode tab 33, and one side part of each anode plate thereof is electrically connected to an anode tab 34.

Other side part of each of the cathode tab 33 and the anode tab 34 is exposed to the outside through a bonding surface 32a of the case 32. Here, it is shown in the drawings that the other side part of the cathode tab 33 is exposed to the outside through a bonding surface at an upper side of the case 32, and the other side part of the anode tab 34 is exposed to the outside through a bonding surface at a lower side of the case 32; however, when the cathode tab 33 and the anode tab 34 are not exposed through the bonding surface at the same side as each other, the other side part of each of the cathode tab 33 and the anode tab 34 may be exposed through a bonding surface at any one side among upper, lower, left and right sides formed in the case 32. Meanwhile, in a case of a single forming schemed battery cell, it is desired that the cathode tab 33 and the anode tab 34 are not exposed to a side end of which the battery cell has a bending part formed therein.

The other side part of the exposed cathode tab 33 is bent toward one surface of the case 32, and is closely adhered and fixed to one surface of the case 32. The cathode tab 33 and the case 32 may be adhered and fixed by general adhesive members. In addition, the other side part of the exposed anode tab 34 is bent toward the other surface of the case 32, and is closely adhered and fixed to the other surface of the case 32. The anode tab 34 and the case 32 may be adhered and fixed by general adhesive members.

The battery cell 30 according to the third exemplary embodiment of the present invention as configured above has a simple configuration as compared to the battery cells 10 and 20 according to the first and second exemplary embodiments of the present invention and does not require an insulation between the cathode tab 33 and the anode tab 34.

The above-described examples are only for illustrating the present invention, and thus, technical idea of the present invention should not be construed as being limited by these examples. The present invention may be variously applied, and may be variously modified without departing from the gist of the present invention claimed in the appended claim. Therefore, it will be apparent to those skilled in the art that modifications and variations can be made without departing from the scope of the invention as defined by the appended claim.

1. A battery cell for a secondary battery comprising:
a battery part including electrode plates disposed at an predetermined interval and a separator provided between each electrode plate;
a case enclosing the battery part; and
a cathode tab and an anode tab each having one side electrically connected to the electrode plate and the other side exposed to an outer side of the battery part,
wherein the outer side of each of the cathode tab and the anode tab is closely adhered to a stacked surface of the case.

2. The battery cell for a secondary battery of claim 1, wherein the other side of the cathode tab is closely adhered to one surface of the case, and
the other side of the anode tab is closely adhered to the other surface of the case.

3. The battery cell for a secondary battery of claim 1, wherein the cathode tab and the anode tab are exposed to the outer side through a bonding surface of the case, the exposed cathode tab is bent toward one surface of the case, the exposed anode tab is bent toward the other surface of the case, and
an insulation layer is formed between the cathode tab and the anode tab on the bonding surface of the case.

4. The battery cell for a secondary battery of claim 1, wherein the cathode tab penetrates through one surface of the case and has the other side part bent so as to contact one surface of the case, and
the anode tab penetrates through the other surface of the case and has the other side part bent so as to contact the other surface of the case.

5. The battery cell for a secondary battery of claim 1, wherein the cathode tab is exposed to an outer side through any one side of the bonding surfaces of the case, and bent toward one surface of the case, and
the anode tab is exposed to an outer side through the other side of the bonding surfaces of the case, and bent toward the other surface of the case.
